(19) United States
(12) Patent Application Publication
(10) Pub. No.: US 2026/0359017 A1
(43) Pub. Date: Nov. 12, 2026

(54) SYSTEMS AND METHODS FOR A SOFTWARE DEVELOPMENT AGENT WITH ISSUE LOCALIZATION

(71) Applicant: Salesforce, Inc., San Francisco, CA (US)

(72) Inventors: Revanth Gangi Reddy, San Francisco, CA (US); Ye Liu, Fremont, CA (US); Xuan Phi Nguyen, Singapore (SG); Semih Yavuz, Redwood City, CA (US); Shafiq Rayhan Joty, San Jose, CA (US)

(21) Appl. No.: 19/330,383

(22) Filed: Sep. 16, 2025

Related U.S. Application Data
(60) Provisional application No. 63/801,617, filed on May 7, 2025.

(51) Int. Cl. G06F 8/35

(52) U.S. Cl. CPC G06F 8/35

(57) ABSTRACT

Embodiments described herein provide a method for automated code generation using machine learning models trained on data from code repositories, issue statements, and known-good patches. The method includes generating training triplets that associate issue statements with modified and unmodified functions from a code repository, and training retrieval and ranking models to identify and prioritize relevant functions based on a user query. Upon receiving a query and a code repository via an integrated development environment, the trained retrieval model selects candidate functions, which are then ranked by the ranker model. A subset of these ranked functions is provided to a code modification model, which modifies at least one function in response to the query.

### CROSS REFERENCE(S)

The instant application is a nonprovisional of and claims priority under 35 U.S.C. 119 to U.S. provisional application No. 63/801,617, filed May 7, 2025, which is hereby expressly incorporated by reference herein in its entirety.

### TECHNICAL FIELD

The embodiments relate generally to machine learning systems for code generation, and more specifically to systems and methods for software issue localization for code generation.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

In the domain of software engineering, AI agents may be trained to automate code generation and assist developers in resolving software issues. A challenge in this context is accurately identifying the specific locations within a codebase that are relevant to a given natural language issue description (referred to as “code localization”), such as a bug report or feature request. Traditional approaches to code localization can be time-consuming and require significant manual effort, often hindering developer productivity. As software systems grow in scale and complexity, there is a growing need for intelligent systems that can efficiently map issue descriptions to relevant code segments and facilitate automated code modification or generation.

### BRIEF DESCRIPTION OF THE DRAWINGS

FIG. 1 illustrates an example operation of an LLM based AI agent, according to embodiments of the present disclosure.

FIG. 2 is a simplified diagram illustrating a data pipeline for a code generation framework according to some embodiments.

FIG. 3 is a simplified diagram illustrating a code generation framework according to some embodiments.

FIG. 4A is a simplified diagram illustrating a computing device implementing the code generation framework described in FIGS. 1-3, according to some embodiments.

FIG. 4B is a simplified diagram illustrating a neural network structure, according to some embodiments.

FIG. 5 is a simplified block diagram of a networked system suitable for implementing the code generation framework described in FIGS. 1-4B and other embodiments described herein.

FIG. 6 is an example logic flow diagram illustrating a method of code generation based on the framework shown in FIGS. 1-5, according to some embodiments.

FIGS. 7-9 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

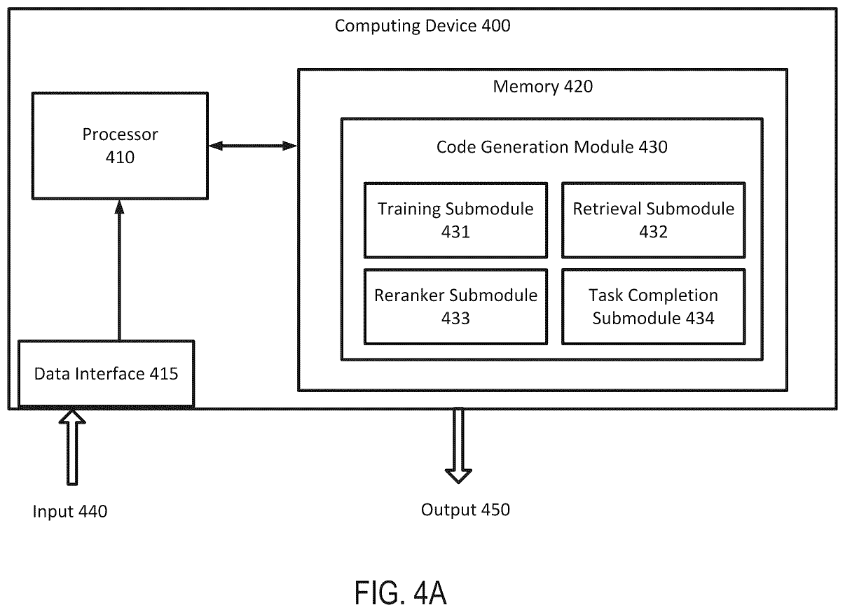

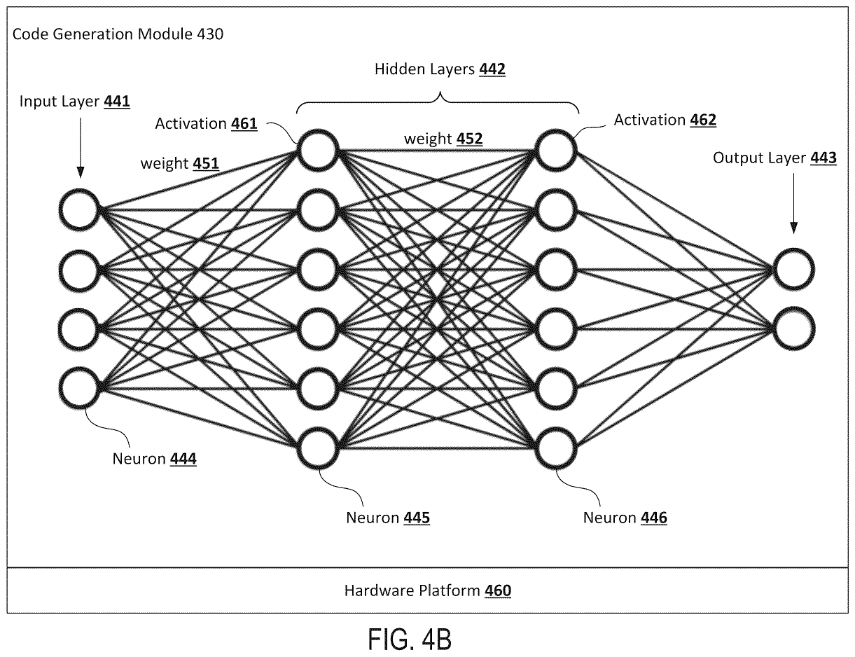

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 4B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pre-exist in the input to such AI system. The new content may include text, images, music, or code. An LLM is an example generative AI model that generates tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task, generating code and/or executing generated code. For example, an AI agent (like a chatbot or virtual assistant) might use an LLM as a component but also integrate tools like web browsing, APIs, databases, and other forms of reasoning to complete tasks.

### Overview

Software issue localization includes the task of identifying the precise code locations (files, classes, or functions) in response to a natural language issue description (e.g., bug report, feature request) of software issues. This task is a critical yet time-consuming aspect of software development. While recent LLM-based agentic approaches demonstrate ability to automatically identify code locations in code files, they often incur significant latency and cost due to computational overhead of complex multi-step reasoning. Alternatively, traditional code ranking models, while less computationally costly than LLM agents, are often only trained for query-to-code or code-to-code retrieval, but may not be able to respond with an accurate answer to a verbose and failure-descriptive issue localization query.

Embodiments herein provide a compute-efficient framework for fine-tuning a retrieval model and/or a re-ranker model for issue localization in software source files using a novel training data generation pipeline. For example, compared with a LLM agent (such as GPT-4o having 200 billion parameters), the retrieval model or the re-ranker model may be a smaller-sized neural network model (e.g., 137 million parameters). The framework may comprise a training data pipeline sourcing raw data from a public dataset including code repositories, issue statements, and known-good patches to a code. The data pipeline then forms training triplets including a statement of the issue, a function from the code repository that was modified for the issue (used as positive sample), and one or more functions from the code repository that were not modified for the issue (negative samples). At training, a retrieval model and/or a reranker model receive a training input of the statement of the issue and generate a training output of an indicated function. The model is then trained via contrastive learning using the triplets of positive and negative samples. The reranker may be trained to generate a list with the training objective being based on generating a positive sample as the first token, and omitting the end of sequence token after. At inference, the trained model may then be implemented as an agent plugin alongside an IDE to spot issues with source code and suggest a possible issue in real-time to improve software engineering efficiency.

In some embodiments, the framework described herein may be embedded and thus operate within an integrated development environment (IDE), allowing developers to quickly identify and address relevant code locations without manually searching through large codebases. In some embodiments, the embedded framework may also indicate and/or open the highest-ranked function directly through the user interface. The approach is flexible and can be extended to handle multiple functions per issue. By automating the mapping of natural language issue descriptions to relevant code segments and facilitating targeted code modifications, these embodiments address a critical bottleneck in modern software development workflows.

In one embodiment, the reranker in this framework may be trained using a listwise objective that only requires the model to correctly identify and rank the single positive function at the top of the candidate list, rather than generating a full ranking of all candidates. This approach offers several technical benefits. First, it significantly simplifies the supervision signal, reducing the complexity of the training process and the amount of annotation required, since only the positive instance needs to be identified among negatives. By omitting the end-of-sequence token during training, the model retains the flexibility to generate full ranked lists during inference, supporting both efficient training and robust deployment. This targeted loss function enables the reranker to focus on distinguishing the most relevant code location for a given issue, improving localization accuracy while reducing computational overhead and training time. As a result, the model achieves high performance in software issue localization tasks without the need for exhaustive ranking supervision.

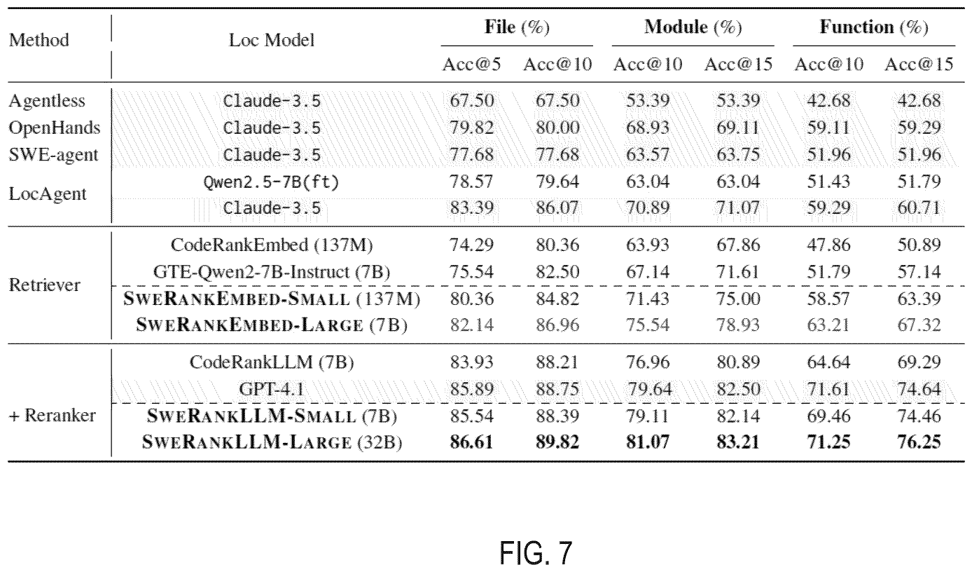

Embodiments herein provide a number of technological improvements to software engineering and AI agent technology. For example, the retrieve-and-rerank framework has been specifically trained on real-world software issue localization data, thereby efficiently and accurately identifying relevant code locations in response to natural language issue descriptions. The framework significantly reduces the time and effort required for developers to locate bugs or implement feature requests. In another example, the use of contrastive training with carefully constructed positive and hard negative examples ensures that the retrieval and ranking models are highly discriminative, leading to improved precision in mapping verbose, descriptive queries to the correct code segments. In another example, the architecture of the software issue localization agent described herein is computationally efficient, achieving rapid inference and low latency even on large codebases, which is particularly advantageous for integration into real-time development environments. In another example, the software issue localization agent achieves superior performance while dramatically lowering inference costs compared to existing agent-based approaches that rely on multiple rounds of large language model interactions, as illustrated in FIGS. 7-9. In another example, the approach is robust and generalizable, as demonstrated by its ability to improve a variety of retriever and reranker models when fine-tuned on the curated dataset, making it adaptable to different software projects and domains.

In this way, both computational resources and operational expenses are improved with the use of the software agents. Therefore, with improved performance on automated software issue localization and code modification, neural network technology in intelligent software engineering tools is improved.

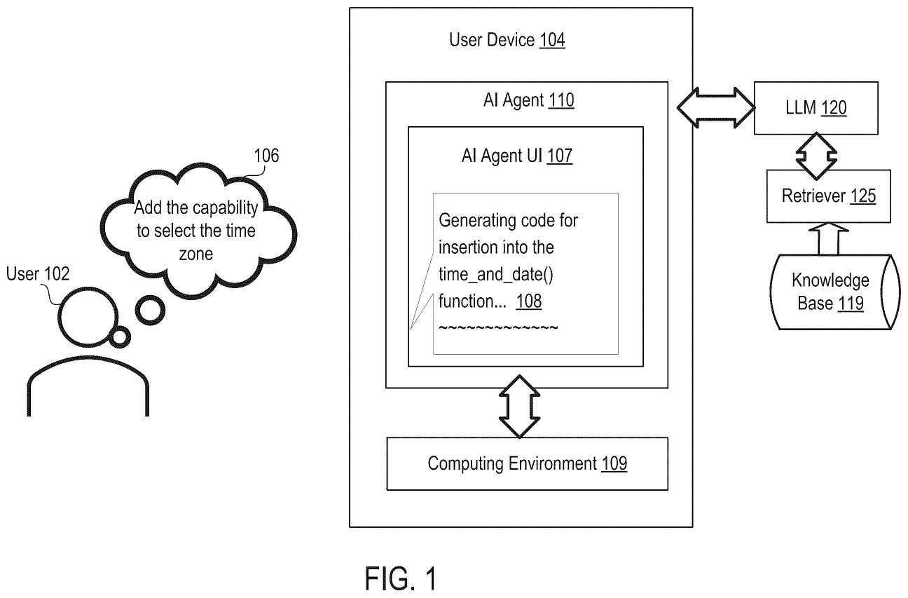

FIG. 1 illustrates an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “add the capability to select the time zone” 106. AI Agent 110 may, in response to the query 106, locate the appropriate file or function to modify in order to add the requested feature, and may generate some response indicating such as “generating code for insertion into the time_and_date( ) function” 108.

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIG. 4B.

The response 108 may include instructions, explanations, code scripts or direct actions to address the task request 106. Such response 108 may be displayed via the AI agent interface 107. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

In this way, the LLM-based AI agent may facilitate end-to-end workflow to automate the task request 106. For code generation tasks, however, large code bases make it difficult to identify a particular file or function which should be modified in order to add a feature or correct a bug. Embodiments described herein provide for a code generation method wherein retrieval and/or ranking models are trained and utilized in identifying the proper locations for code generation, as further described below.

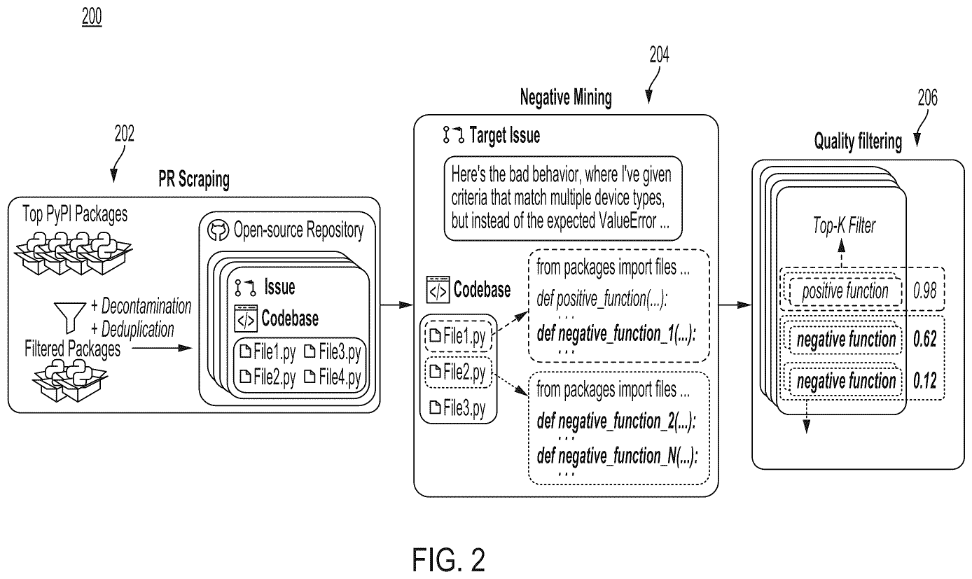

FIG. 2 is a simplified diagram illustrating a data pipeline for a code generation framework 200 according to some embodiments. Framework 200 orchestrates the construction of a high-quality training dataset for code retrieval and ranking models, supporting automated code generation and modification. Framework 200 comprises several components, including pull request (PR) scraping 202, negative mining 204, and quality filtering 206, each of which may contribute to the data generation process.

In some embodiments, PR scraping 202 initiates the pipeline by selecting relevant code repositories from public sources, such as GitHub. The selection process is governed by strict criteria to ensure the quality and relevance of the data. Specifically, PR scraping 202 may select repositories from a database of repositories (e.g., an online code repository such as GitHub). PR scraping 202 may select repositories based on one or more criteria. For example, repositories may be selected which are the top ranked repositories by some metric (e.g., most viewed, most downloaded, etc.). In some embodiments, a criteria may be the percentage of the code in a repository that is a specified programming language. For example, in generating training data for the Python programming language, repositories may be selected which have above some threshold level (e.g., 80%) of the code in Python. Different criteria may be used in combination. For example, of the top 10,000 ranked repositories, only those with over 80% of the code written in python may be selected.

To further enhance dataset quality and avoid redundancy, PR scraping 202 may perform deduplication based on source code overlap, removing near-identical repositories. Deduplication may be performed, for example, by identifying and removing a repository if it has above a predetermined threshold percentage of identical code to another repository. Additionally, repositories that overlap with existing benchmarks, such as SWE-Bench and LocBench, may be excluded to prevent data leakage. This rigorous selection process results in a curated set of repositories.

Following repository selection, PR scraping 202 may identify relevant pull requests (PRs) within these repositories. A pull request is a proposed change to a codebase submitted by a contributor, typically for review and integration into the main project. The criteria for PR selection may require that each PR be explicitly linked to resolving an issue within the same repository. The criteria for PR selection may require that the PR includes modifications to test files, which serves as a proxy for issue resolution verification. For each qualifying PR, PR scraping 202 extracts the associated issue statement and the snapshot of the codebase corresponding to the PR's base commit. This process yields initial (PR, codebase) pairs, providing a substantial foundation for downstream data construction. The selected PRs may include a wide range of query lengths and edit granularities. The selected PRs may include code edits which are concentrated within a single code unit, and may include code edits that span multiple files, modules, or functions.

Negative mining 204 is responsible for constructing the training tuples that form the training dataset. For each (PR, codebase) pair, negative mining 204 generates a set of training triplets, each comprising an issue statement, a positive function, and one or more negative functions. Each function modified within a PR is designated as a positive example, and thus, a PR modifying N functions may yield N distinct training instances. The negatives for each instance may be defined as all unmodified functions from the corresponding codebase snapshot.

To ensure the quality and discriminative power of the training data, quality filtering 206 implements a two-step process: consistency filtering and hard negative mining. Consistency filtering may use a pre-trained embedding model to compute semantic similarity between the issue statement and each candidate function in the codebase. For each training instance, the positive code snippet may be retained only if it ranks within the top K (e.g., K=20) functions in similarity to the issue statement, relative to all other functions in the repository. This formal process ensures that only those instances where the positive function is semantically aligned with the issue description are included in the final dataset. Hard negative mining further refines the negative set by selecting the top M (e.g., M=15) most similar functions to the query among the negatives, thereby providing challenging negative examples that enhance the effectiveness of contrastive learning.

This comprehensive data pipeline ensures that the final dataset is both large-scale and high-quality, providing a robust foundation for training retrieval and ranking models as described below. Framework 200 thus enables the automated identification and ranking of relevant code functions in response to user queries, supporting downstream code modification and generation tasks, for example within an integrated development environment.

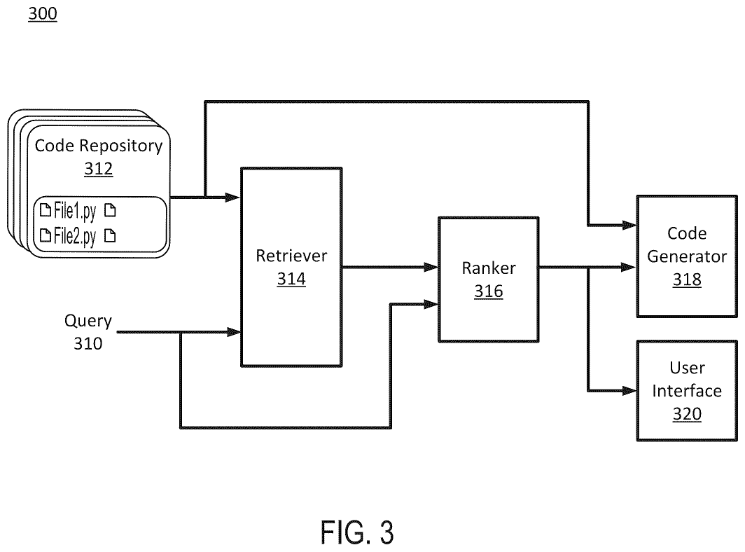

FIG. 3 is a simplified diagram illustrating a code generation framework 300 for an AI software agent according to some embodiments. Framework 300 is designed to facilitate automated code generation and modification in response to user queries, such as feature requests or bug descriptions, by leveraging advanced retrieval and ranking models trained on real-world software development data (e.g., as described in FIG. 2). For example, an AI software engineering agent (e.g., similar to AI agent 110 in FIG. 1) may be built on the retriever model 314, ranker model 316, a code generator model 318 that operatively interact with a user interface 320 to provide a generated output.

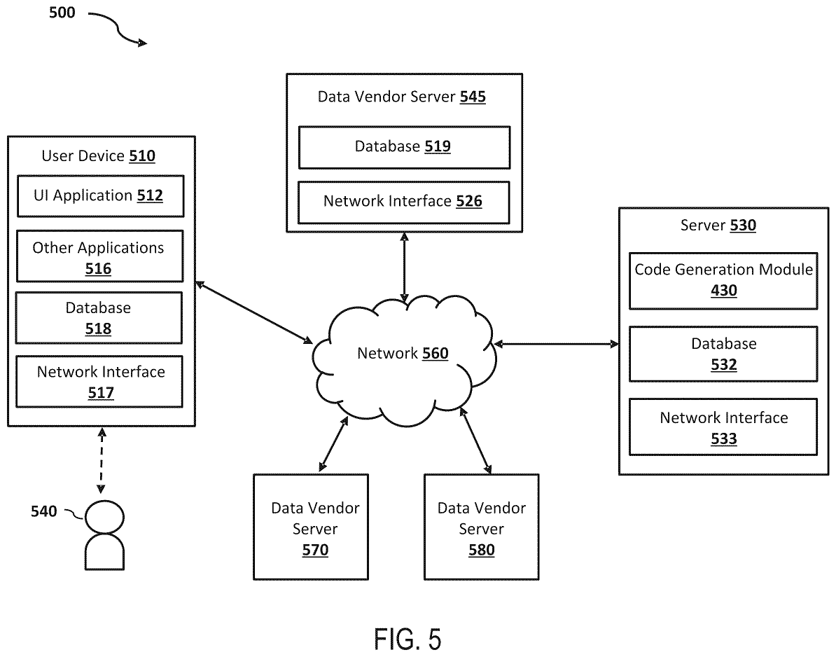

In one embodiment, the AI software agent may be embedded in an IDE. For example, the framework 300 may comprise a client component and/or a remote server component. One or more of the code repository 312, retriever model 314, ranker model 316 and code generator model 318 may be deployed on a user device, or be deployed at a remote server that is accessible by the client component. For example, a client-side software engineering tool may be embedded in an IDE running on a client device, which constantly, intermittently, and/or on a user demand basis monitor the code development within the IDE. The client-side software engineering tool may receive the query 310 directly from the user interface of the IDE, or may generate the query while monitoring the code. For example, when an “auto-check” configuration is turned on, the client-side software engineering tool may periodically capture a segment of newly programmed code, combining with a system prompt to identify whether this segment contains a certain issue as the query 310 to transmit to the retriever 314 deployed at the server side. The networked architecture of the client-server interaction may be described in relation to FIG. 5.

During inference, framework 300 operates as follows. A user provides a query 310, which may be a natural language description of a software issue, such as a bug report or feature request. This query 310, along with code repository 312 containing a plurality of files and functions, is input to retriever 314. Retriever 314 may be implemented as a bi-encoder model, which encodes both the query 310 and each candidate function from code repository 312 into dense vector representations within a shared embedding space. The bi-encoder architecture enables efficient computation of similarity scores between the query and all candidate functions. Specifically, retriever 314 may compute the cosine similarity between the embedding of query 310 and the embeddings of each function in code repository 312, thereby ranking the candidate functions according to their relevance to the query. The top-ranked functions, as determined by these similarity scores, are then passed to ranker 316 for further refinement.

Ranker 316 may be implemented as a listwise reranker model, which receives as input the query 310 and the set of top candidate functions retrieved by retriever 314. In some embodiments, each candidate function is assigned a unique numerical identifier, and the input to ranker 316 is constructed as a prompt containing the query and the list of candidate functions with their identifiers. Ranker 316 is trained to generate a ranking permutation of the candidate identifiers, with the objective of maximizing the likelihood that the identifier corresponding to the true relevant function (i.e., the function that should be modified to address the query) is ranked first.

The output of ranker 316 is a refined ranking of the candidate functions, which is then provided to code generator 318. Code generator 318 receives as input the code repository 312, the original query 310, and the ranking produced by ranker 316. Based on this information, code generator 318 can generate code modifications to the highest-ranked functions, generating patches or code suggestions that address the user's query 310. In some embodiments, the highest-ranked function or file, along with the proposed modification, is displayed to the user via user interface 320, enabling interactive review and acceptance of the suggested changes. The granularity at which retrieving and ranking are performed may be at the level of function, module, file, or other hierarchical division of code.

The training process for framework 300 is designed to ensure that retriever 314 and ranker 316 are highly effective at identifying and ranking relevant code locations in response to natural language queries. As described in FIG. 2, training data is constructed from real-world software development activities, such as pull requests and issue statements from public code repositories. For each training instance, a triplet is generated consisting of an issue statement (serving as query 310), a positive function (a function modified by a known-good patch in the associated code repository), and one or more negative functions (functions not modified by the patch). Retriever 314 may be trained using a contrastive loss function, such as InfoNCE, which encourages the embedding of the query to be more similar to the embedding of the positive function than to the embeddings of negative functions. The loss may be computed over a batch of training instances, with the denominator including both other positive code embeddings and hard negative embeddings. In some embodiments, retriever 314 is trained to select the positive function as a highest ranked function from the list of functions given the issue statement.

Ranker 316 may be trained in a listwise fashion using the same triplet-based data. For each training instance, a fixed number of negative functions may be sampled to fit a listwise reranking window (e.g., 10 candidates in total), and the order of candidates is shuffled to prevent positional bias. The input prompt for ranker 316 during training may be constructed by concatenating the query and the candidate functions with their assigned identifiers. The model may be trained to maximize the likelihood of generating the identifier of the positive function as the first output token, with the end-of-sequence token omitted after this prediction. This allows for training where the desired highest ranked element is known (i.e., the positive sample) but with no relative ground truth ranking among the negative samples.

During training, since only the positive function is known, the model is trained to output the identifier of the positive function as the top-ranked candidate, and the end-of-sequence token is omitted after this prediction to preserve the model's ability to generate full ranked lists during inference. This adaptation allows ranker 316 to be fine-tuned for software issue localization tasks without requiring full supervision over the ranking of all candidates. The training objective of the ranker may be represented as:

$${ℒ}_{LM} = - log ( {P}_{θ} ( {I}_{i}^{+} \vert x ) ) \qquad ( 1 )$$

where x is the input prompts constructed from the issue tᵢ and the set of candidate functions including the positive function and the set of negative functions along with their assigned identifiers.

$${I}_{i}^{+}$$

represents the positive function. P_{θ} represents the listwise reranker. In some embodiments, the listwise reranker is an LLM. During training, the end-of-sequence token is omitted after predicting

$${I}_{i}^{+}$$

to retain the moder's capability to generate full ranked lists for inference, as required by the listwise format.

To handle long queries and candidate functions that may exceed the model's maximum context window, both queries and candidate codes may be truncated as needed, preserving as much meaningful context as possible within the allowed input length. During training, retriever 314 and ranker 316 may be initialized from pre-trained models, and then fine-tuned on the curated training dataset. Training may be performed using multi-GPU setups (e.g., 8 or 16 GH200 GPUs), with hyperparameters such as learning rates, batch sizes, number of epochs, and the use of noisy embeddings selected to optimize performance.

The overall design of framework 300, including the use of bi-encoder retriever 314 and listwise reranker 316, enables highly accurate and efficient localization of relevant code for modification in response to user queries. The system is robust to noisy or verbose queries, generalizes well to new issue types, and can be fine-tuned for different software engineering tasks without requiring exhaustive ranking supervision.

### Computer and Network Environment

FIG. 4A is a simplified diagram illustrating a computing device implementing the code generation framework described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for code generation module 430 that may be used to implement and/or emulate the systems and models, and/or to implement any of the methods described further herein. code generation module 430 may receive input 440 such as an input training data (e.g., training triplets as described in FIG. 2) via the data interface 415 and generate an output 450 which may be an indication of a piece of code, or a modification of the identified code.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a query, from a user via the user interface.

In some embodiments, the code generation module 430 is configured to generate code as described herein. The code generation module 430 may further include training submodule 431 configured to train the retriever and/or reranker models as described herein, which may include generating data as described in FIG. 2. The code generation module 430 may further include retrieval submodule 432 configured to perform retrieval via a trained retriever model as described herein. The code generation module 430 may further include reranker submodule 433 configured to rank retrieved code sections via a trained reranker model as described herein. The code generation module 430 may further include task completion submodule 434 configured to complete the task as indicated in the user query, which may include modifying identified code and/or performing other agentic operations as described herein.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the code generation module 430 described in FIG. 4A, according to some embodiments. In some embodiments, the code generation module 430 and/or one or more of its submodules 431-434 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a query. The number of nodes (neurons) in the input layer 441 may be determined by the dimensionality of the input data (e.g., the length of a vector of the query). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the code generation module 430 receives an input 440 of a query and transforms the input into an output 450 of a response which may be an indication of a code section or generated code. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the code generation module 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be an LLM-based reranker model, and/or the like.

In one embodiment, the code generation module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q Kand V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the code generation module 430 and its submodules 431-434 may be implemented by hardware, software and/or a combination thereof. For example, the code generation module 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the code generation module 430 and its submodules 431-434 and/or any other neural network models such as retriever 314 or ranker 316 described in FIG. 3 onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the code generation module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the code generation module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the code generation module 430 and its submodules 431-434 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the code generation module 430 may generate, by at least one ASIC (such as a TPU, etc.) performing a multiplicative and/or accumulative operation for a neural network language model, a next token based at least in part on previously generated tokens, and in turn generate a natural language output representing the next-step action combining a sequence of generated tokens.

In one embodiment, the neural network based code generation module 430 and one or more of its submodules 431-434 may be trained by iteratively updating the underlying parameters (e.g., weights 451, 452, etc., bias parameters and/or coefficients in the activation functions 461, 462 associated with neurons) of the neural network based on the loss described in Eq. (1). For example, during forward propagation, the training data such as the triplets described in FIGS. 2-3 are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding ground truth code section (e.g., a function)) from the training data, to compute a loss function that measures the discrepancy between the predicted output and the expected output. For example, the loss function may be according to Eq. (1). Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based code generation module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like, such as in Eq. (1). These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In some embodiments, code generation module 430 and its submodules 431-434 may be housed at a centralized server (e.g., computing device 400) or one or more distributed servers. For example, one or more of code generation module 430 and its submodules 431-434 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen code repositories.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in code generation and more generally agentic AI.

FIG. 5 is a simplified block diagram of a networked system 500 suitable for implementing the code generation framework described in FIGS. 1-4B and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating an identified function or other code section from the server 530 and display the message via the UI application 512. In other embodiments, user device 510 may include additional or different modules having specialized hardware and/or software as required.

In one embodiment, UI application 512 may communicatively and interactively generate a UI for an AI agent implemented through the code generation module 430 (e.g., an LLM agent) at server 530. In at least one embodiment, a user operating user device 510 may enter a user utterance, e.g., via text or audio input, such as a question, uploading a document, and/or the like via the UI application 512. Such user utterance may be sent to server 530, at which code generation module 430 may generate a response via the process described in FIGS. 1-4B. The code generation module 430 may thus cause a display of an identified code portion or generated code at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view code, including generated code.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including code repositories with pull requests to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the code generation module 430 and its submodules described in FIG. 4A. In some implementations, code generation module 430 may receive data from database 519 at the data vendor server 545 via the network 560 to generate code. The generated code may also be sent to the user device 510 for review by the user 540 via the network 560.

In one embodiment, an AI agent implementing the code generation module 430 and its submodules described in FIG. 4A may be built based on an LLM as described in FIG. 4B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the code generation module 430 and its submodules described in FIG. 4A may be implemented as a cloud-based AI agent which may be accessed by user device 510 via a chatbot application, a web application, customer support or SaaS applications. In another implementation, a client-side AI agent component may be delivered from the server 530 to user device 510 for local installation such that the client-side AI agent may be installed and runs directly on the user's device. Such local AI agent on the user device 510 may be available offline to adapt to privacy-sensitive applications. In another implementation, the AI agent implementing the code generation module 430 and its submodules described in FIG. 4A may adopt a hybrid cloud and client-based structure to balance computing speed, cost and privacy. For example, a local AI agent may handle basic AI queries locally, but complex queries may be sent to server 530 to process.

The database 532 may be stored in a transitory and/or non-transitory memory of the server 530. In one implementation, the database 532 may store data obtained from the data vendor server 545. In one implementation, the database 532 may store parameters of the code generation module 430. In one implementation, the database 532 may store previously generated code, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

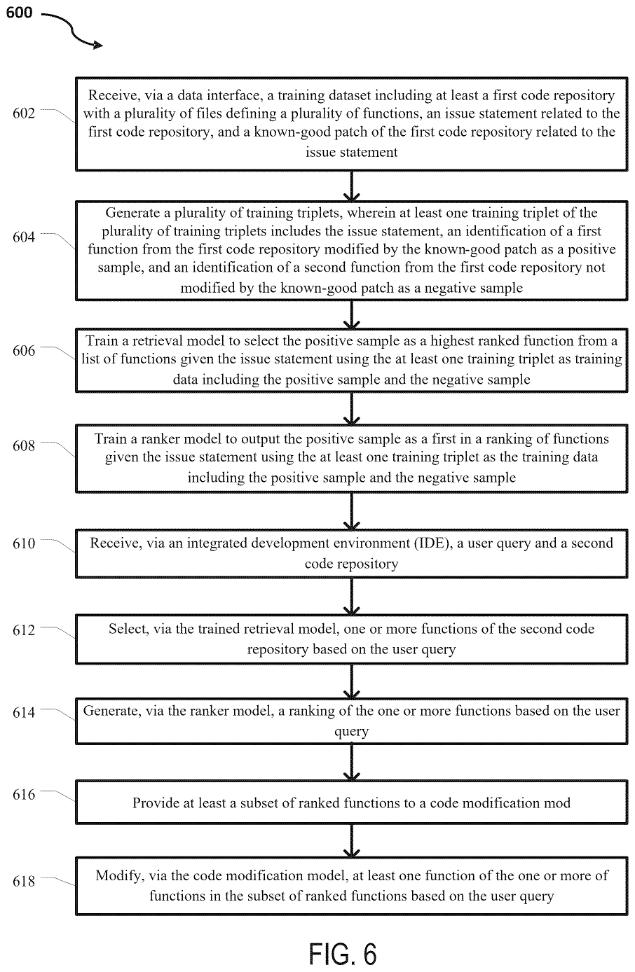

FIG. 6 is an example logic flow diagram illustrating a method of code generation based on the framework shown in FIGS. 1-5, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the code generation module 430 (e.g., FIGS. 4A and 5) that performs training and/or code generation as described herein.

In some embodiments, method 600 is performed by a system such as computing device 400, user device 510, server 530, or another device or combination of devices. Inputs (e.g., user queries) may be received via a data interface such as data interface 415, network interface 517, network interface 533, or via a data interface that is integrated with a device. For example UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, the system receives, via a data interface (e.g., data interface 415 or network interface 517 or 533), a training dataset including at least a first code repository with a plurality of files defining a plurality of functions, an issue statement related to the first code repository, and a known-good patch of the first code repository related to the issue statement.

At step 604, the system generates a plurality of training triplets, wherein at least one training triplet of the plurality of training triplets includes the issue statement, an identification of a first function from the first code repository modified by the known-good patch as a positive sample, and an identification of a second function from the first code repository not modified by the known-good patch as a negative sample. In some embodiments, the at least one training triplet includes the identification of the first function as the positive sample in response to the first function being above a predefined threshold level of semantic similarity to the issue statement based on a cosine similarity metric in a vector-space representation. In some embodiments, the at least one training triplet includes the identification of the second function as the negative sample in response to the second function being above a predefined threshold level of semantic similarity to the issue statement based on a cosine similarity metric in a vector-space representation. In some embodiments, a set of negative samples is identified, with each being a function not modified by the known-good patch.

At step 606, the system trains a retrieval model (e.g., retriever 314) to select the positive sample as a highest ranked function from a list of functions given the issue statement using the at least one training triplet as training data including the positive sample and the negative sample (or set of negative samples). In some embodiments, a second training triplet of the plurality of training triplets includes the issue statement, an identification of a third function from the first code repository modified by the known-good patch as a second positive sample, and an identification of a fourth function from the first code repository not modified by the known-good patch as a second negative sample, wherein the third function is different than the first function. In some embodiments, the system further trains the retrieval model to select the second positive sample as a highest ranked from the list of functions given the issue statement using the second training triplet as training data including the second positive sample and the second negative sample.

At step 608, the system trains a ranker model (e.g., ranker 316) to output the positive sample as a first in a ranking of functions given the issue statement using the at least one training triplet as the training data including the positive sample and the negative sample (or set of negative samples). In some embodiments, training the reranker model includes computing an objective function that does not change based on ordering of the ranked outputs after the first output, other than not having an end of sequence token as the second output. For example, the loss function of equation (1) allows the reranker to be trained using a listwise objective that only requires the model to correctly identify and rank the single positive function at the top of the candidate list, rather than generating a full ranking of all candidates.

At step 610, the system receives, via an integrated development environment (IDE), a user query (e.g., query 310) and a second code repository. The user query may describe a new issue or feature request, and the second code repository may be different from the first, allowing the trained models to be applied to new projects and contexts.

At step 612, the system selects, via the trained retrieval model, one or more functions of the second code repository based on the user query. The retrieval model efficiently narrows down the set of candidate functions that are most likely relevant to the user's query, leveraging the learned representations from the training phase.

At step 614, the system generates, via the ranker model, a ranking of the one or more functions based on the user query. In some embodiments, the ranking outputs an identification (e.g., an ID number) associated with the one or more functions in a ranked order.

At step 616, the system provides at least a subset of ranked functions to a code modification model. The subset may include the top-ranked functions, which are most likely to require modification according to the user query and the model's learned ranking. In some embodiments (4), the system provides at least the subset of ranked functions to the code modification model by providing a file of the plurality of files containing a highest ranked function in the ranking of the one or more functions. This ensures that the code modification model receives the most relevant context for generating or suggesting code changes.

At step 618, the system modifies, via the code modification model (e.g., code generator 318), at least one function of the one or more functions in the subset of ranked functions based on the user query.

In some embodiments, the system indicates, via a user interface (e.g., user interface 320 or UI application 512), a highest ranked function in the ranking of the one or more functions. This provides guidance to the user, highlighting the function most likely to be relevant for modification or review.

Embodiments described herein have a wide range of practical applications that deliver tangible technical benefits and improve the functioning of computer systems. In the context of software development, these embodiments can be integrated into modern integrated development environments (IDEs) to automate the process of software issue localization and code modification. By leveraging advanced retrieval and ranking models trained on real-world code repositories and issue statements, the system can rapidly identify the most relevant functions or files in a codebase that are likely responsible for a reported bug or feature request. The ability to automatically suggest and even implement code modifications based on ranked function relevance streamlines the software maintenance lifecycle, leading to more reliable and maintainable codebases.

In the field of information technology (IT) diagnostics and control, embodiments described herein can be deployed to monitor and analyze large-scale software systems for faults or performance bottlenecks. By continuously processing logs, error reports, and system telemetry, the models can localize the root cause of failures to specific code components, enabling rapid triage and targeted remediation. This approach enhances the efficiency of IT support operations, minimizes system downtime, and optimizes resource allocation by ensuring that only the most relevant parts of the codebase are examined or modified.

In another application area, embodiments described herein can be utilized in the domain of scientific computing and research data management. Large-scale scientific software often involves intricate codebases with numerous interdependent modules. When computational errors or unexpected results arise, the described models can assist by pinpointing the precise functions or scripts responsible for the anomaly, based on natural language descriptions of the observed behavior.

### Example Results

FIGS. 7-9 provide charts illustrating exemplary performance of embodiments described herein, with a comprehensive evaluation of an embodiment of the framework for software issue localization (referred to in the charts as “SWERANK”). The experiments assess the effectiveness and efficiency of SWERANK compared to a range of state-of-the-art agent-based and ranking-based baseline models. The baseline models used for comparison include agent-based methods such as MoatlessTools (Orwall, Moatless tools, 2024), SWE-Agent (Yang et al., Swe-agent: Agent-computer interfaces enable automated software engineering, arXiv: 2405.15793, 2024), OpenHands (Wang et al., Openhands: An open platform for AI software developers as generalist agents, ICLR, 2025), and LocAgent (Chen et al., Locagent: Graph-guided Ilm agents for code localization, arXiv: 2503.09089, 2025), as well as agentless approaches (Xia et al., Agentless: Demystifying Ilm-based software engineering agents, arXiv: 2407.01489, 2024). Retrieve-and-rerank baselines include BM25 (Robertson et al., Okapi at tree-3, Text Retrieval Conference, 1994), Jina-Code-v2 (Günther et al., Jina embeddings: A novel set of high-performance sentence embedding models, arXiv: 2307.11224, 2023), Codesage-large-v2 (Zhang et al., Code representation learning at scale, ICLR, 2024), CodeRankEmbed (Suresh et al., Cornstack: High-quality contrastive data for better code ranking, arXiv: 2412.01007, 2024), SFR-Embedding-2 (Meng et al., Sfr-embedding-2: Advanced text embedding with multi-stage training, 2024), and GTE-Qwen2-7B-Instruct (Li et al., Towards general text embeddings with multi-stage contrastive learning, arXiv: 2308.03281, 2023). For reranking, models such as CodeRankLLM (Suresh et al., Cornstack: High-quality contrastive data for better code ranking, arXiv: 2412.01007, 2024) and GPT-4.1 were included. The primary evaluation metric is Accuracy at k (Acc@k), which measures the percentage of cases where all relevant code locations are correctly identified within the top-k results. This metric is reported at three granularities: file, module (class), and function. The experiments were conducted on the SWE-Bench-Lite (Jimenez et al., Swe-bench: Can language models resolve real-world github issues?, arXiv: 2310.06770, 2023) and LocBench (Chen et al., Locagent: Graph-guided Ilm agents for code localization, arXiv: 2503.09089, 2025) benchmarks, which include real-world bug reports, feature requests, and other issue types. Cost-efficiency was also evaluated by comparing the average inference cost per instance for each method.

FIG. 7 illustrates the comparative performance of different localization methods on the SWE-Bench-Lite benchmark. The results indicate that the SWERANK models surpass the performance of all evaluated agent-based methods. The SWERANKEMBED-SMALL model, despite its relatively small size of 137M parameters, demonstrates highly competitive performance, outperforming prior 7B parameter embedding models. Notably, SWERANKEMBED-LARGE achieves higher Acc@10 scores for file and module localization than LocAgent utilizing Claude-3.5. This illustrates how the embodiments described herein are able to perform the task of code localization utilizing fewer memory and processing resources. Employing the SWERANKLLM reranker subsequently enhances the retriever's output, establishing a new state-of-the-art for localization performance on this benchmark, exceeding the performance of even closed-source models across file, module, and function granularities.

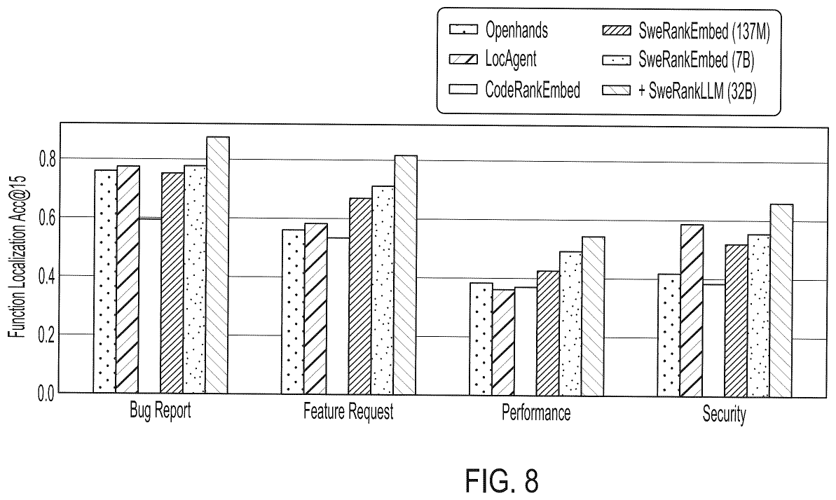

FIG. 8 illustrates the function localization performance comparison across different categories within LocBench. The approach incorporating the SWERANKLLM reranker considerably outperforms other agent-based methods powered by Claude-3.5. The large variants of SWERANKEMBED and SWERANKLLM set new state-of-the-art performance, and despite being primarily trained with bug reports in SWELOC, the SWERANK models demonstrate impressive generalizability across other categories.

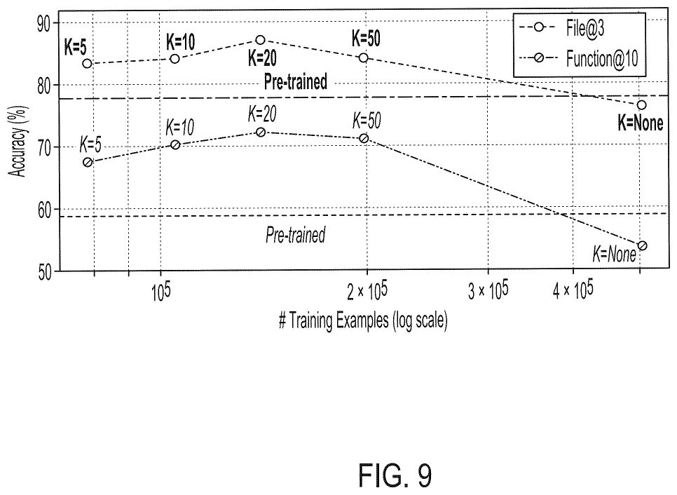

FIG. 9 illustrates the effect of SWELOC data filtering on SWE-Bench-Lite performance. The results suggest that neither overly strict (low K) nor overly weak (high K) filtering criteria lead to optimal performance. A moderate K value (here, K=20) appears preferable, achieving a balance between data quality and dataset size. Conversely, omitting filtering entirely (K=None) proves detrimental, resulting in a performance decrease after finetuning. This analysis validates the improvements achieved by both data quality and size, highlighting that simply increasing data volume without ensuring quality can negatively impact performance.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for code generation, comprising:
receiving, via a data interface, a training dataset including at least a first code repository with a plurality of files defining a plurality of functions, an issue statement related to the first code repository, and a known-good patch of the first code repository related to the issue statement;
generating a plurality of training triplets, wherein at least one training triplet of the plurality of training triplets includes the issue statement, an identification of a first function from the first code repository modified by the known-good patch as a positive sample, and an identification of a second function from the first code repository not modified by the known-good patch as a negative sample;
training a retrieval model to select the positive sample as a highest ranked function from a list of functions given the issue statement using the at least one training triplet as training data including the positive sample and the negative sample;
training a ranker model to output the positive sample as a first in a ranking of functions given the issue statement using the at least one training triplet as the training data including the positive sample and the negative sample;
receiving, via an integrated development environment (IDE), a user query and a second code repository;
selecting, via the trained retrieval model, one or more functions of the second code repository based on the user query;
generating, via the ranker model, a ranking of the one or more functions based on the user query;
providing at least a subset of ranked functions to a code modification model; and
modifying, via the code modification model, at least one function of the one or more of functions in the subset of ranked functions based on the user query.

2. The method of claim 1, wherein the at least one training triplet includes the identification of the first function as the positive sample in response to the first function being above a predefined threshold level of semantic similarity to the issue statement based on a cosine similarity metric in a vector-space representation.

3. The method of claim 1, wherein the at least one training triplet includes the identification of the second function as the negative sample in response to the second function being above a predefined threshold level of semantic similarity to the issue statement based on a cosine similarity metric in a vector-space representation.

4. The method of claim 1, wherein the providing at least the subset of ranked functions to the code modification model includes providing a file of the plurality of files containing a highest ranked function in the ranking of the one or more functions.

5. The method of claim 1, wherein a second training triplet of the plurality of training triplets includes the issue statement, an identification of a third function from the first code repository modified by the known-good patch as a second positive sample, and an identification of a fourth function from the first code repository not modified by the known-good patch as a second negative sample, wherein the third function is different than the first function.

6. The method of claim 5, further comprising:
further training the retrieval model to select the second positive sample as a highest ranked from the list of functions given the issue statement using the second training triplet as training data including the second positive sample and the second negative sample.

7. The method of claim 1, further comprising indicating, via a user interface, a highest ranked function in the ranking of the one or more functions.

8. A system for code generation, the system comprising:
a memory that stores a retrieval model and a ranker model and a plurality of processor executable instructions;
a communication interface that receives a training dataset including at least a first code repository with a plurality of files defining a plurality of functions, an issue statement related to the first code repository, and a known-good patch of the first code repository related to the issue statement; and
one or more hardware processors that read and execute the plurality of processor-executable instructions from the memory, wherein the plurality of processor-executable instructions are configurable to cause the system to perform operations comprising:
generating a plurality of training triplets, wherein at least one training triplet of the plurality of training triplets includes the issue statement, an identification of a first function from the first code repository modified by the known-good patch as a positive sample, and an identification of a second function from the first code repository not modified by the known-good patch as a negative sample;
training a retrieval model to select the positive sample as a highest ranked function from a list of functions given the issue statement using the at least one training triplet as training data including the positive sample and the negative sample;
training a ranker model to output the positive sample as a first in a ranking of functions given the issue statement using the at least one training triplet as the training data including the positive sample and the negative sample;
receiving, via an integrated development environment (IDE), a user query and a second code repository;
selecting, via the trained retrieval model, one or more functions of the second code repository based on the user query;
generating, via the ranker model, a ranking of the one or more functions based on the user query;
providing at least a subset of ranked functions to a code modification model; and
modifying, via the code modification model, at least one function of the one or more of functions in the subset of ranked functions based on the user query.

9. The system of claim 8, wherein the at least one training triplet includes the identification of the first function as the positive sample in response to the first function being above a predefined threshold level of semantic similarity to the issue statement based on a cosine similarity metric in a vector-space representation.

10. The system of claim 8, wherein the at least one training triplet includes the identification of the second function as the negative sample in response to the second function being above a predefined threshold level of semantic similarity to the issue statement based on a cosine similarity metric in a vector-space representation.

11. The system of claim 8, wherein the providing at least the subset of ranked functions to the code modification model includes providing a file of the plurality of files containing a highest ranked function in the ranking of the one or more functions.

12. The system of claim 8, wherein a second training triplet of the plurality of training triplets includes the issue statement, an identification of a third function from the first code repository modified by the known-good patch as a second positive sample, and an identification of a fourth function from the first code repository not modified by the known-good patch as a second negative sample, wherein the third function is different than the first function.

13. The system of claim 12, the operations further comprising:
further training the retrieval model to select the second positive sample as a highest ranked from the list of functions given the issue statement using the second training triplet as training data including the second positive sample and the second negative sample.

14. The system of claim 8, the operations further comprising:
indicating, via a user interface, a highest ranked function in the ranking of the one or more functions.

15. A non-transitory machine-readable medium comprising a plurality of instructions, executable by one or more processors, wherein the plurality of instructions are configurable to cause the one or more processors to perform operations comprising:
receiving, via a data interface, a training dataset including at least a first code repository with a plurality of files defining a plurality of functions, an issue statement related to the first code repository, and a known-good patch of the first code repository related to the issue statement;
generating a plurality of training triplets, wherein at least one training triplet of the plurality of training triplets includes the issue statement, an identification of a first function from the first code repository modified by the known-good patch as a positive sample, and an identification of a second function from the first code repository not modified by the known-good patch as a negative sample;
training a retrieval model to select the positive sample as a highest ranked function from a list of functions given the issue statement using the at least one training triplet as training data including the positive sample and the negative sample;
training a ranker model to output the positive sample as a first in a ranking of functions given the issue statement using the at least one training triplet as the training data including the positive sample and the negative sample;
receiving, via an integrated development environment (IDE), a user query and a second code repository;
selecting, via the trained retrieval model, one or more functions of the second code repository based on the user query;
generating, via the ranker model, a ranking of the one or more functions based on the user query;
providing at least a subset of ranked functions to a code modification model; and
modifying, via the code modification model, at least one function of the one or more of functions in the subset of ranked functions based on the user query.

16. The non-transitory machine-readable medium of claim 15, wherein the at least one training triplet includes the identification of the first function as the positive sample in response to the first function being above a predefined threshold level of semantic similarity to the issue statement based on a cosine similarity metric in a vector-space representation.

17. The non-transitory machine-readable medium of claim 15, wherein the at least one training triplet includes the identification of the second function as the negative sample in response to the second function being above a predefined threshold level of semantic similarity to the issue statement based on a cosine similarity metric in a vector-space representation.

18. The non-transitory machine-readable medium of claim 15, wherein the providing at least the subset of ranked functions to the code modification model includes providing a file of the plurality of files containing a highest ranked function in the ranking of the one or more functions.

19. The non-transitory machine-readable medium of claim 15, wherein a second training triplet of the plurality of training triplets includes the issue statement, an identification of a third function from the first code repository modified by the known-good patch as a second positive sample, and an identification of a fourth function from the first code repository not modified by the known-good patch as a second negative sample, wherein the third function is different than the first function.

20. The non-transitory machine-readable medium of claim 19, the operations further comprising:
further training the retrieval model to select the second positive sample as a highest ranked from the list of functions given the issue statement using the second training triplet as training data including the second positive sample and the second negative sample.
